(19) United States
(12) Patent Application Publication
(10) Pub. No.: US 2015/0105069 A1
(43) Pub. Date: Apr. 16, 2015

(54) TERRESTRIAL COMMUNICATION METHOD, APPARATUS, AND SYSTEM

(71) Applicant: Electronics and Telecommunications Research Institute, Daejeon (KR)

(72) Inventor: Tae Chul HONG, Daejeon (KR)

(21) Appl. No.: 14/303,143

(22) Filed: Jun. 12, 2014

(30) Foreign Application Priority Data
Oct. 14, 2013 (KR) 10-2013-0122027

(51) Int. Cl. H04B 7/155; H04W 74/08

(52) U.S. Cl. CPC H04B 7/15542; H04W 74/0808
USPC 455/430

(57) ABSTRACT

Provided are a terrestrial communication method, an apparatus, and a system, wherein the system uses a first frequency used in a satellite communication system, detect a terminal of the satellite communication system in a cell of the terrestrial communication system, and perform downlink transmission using the first frequency when the terminal is not detected.

### CROSS-REFERENCE TO RELATED APPLICATION

This application claims the priority benefit of Korean Patent Application No. 10-2013-0122027, filed on Oct. 14, 2013, in the Korean Intellectual Property Office, the disclosure of which is incorporated herein by reference.

### BACKGROUND

1. Field of the Invention

The present invention relates to terrestrial communication technology, and more particularly, to a method, an apparatus, and a system for enabling a terrestrial communication system to use an identical frequency to a satellite communication system.

2. Description of the Related Art

In a satellite communication system, when a plurality of beams is used for communication, it may be necessary to prevent an occurrence of interference between beams adjacent to each other. To prevent an occurrence of interference, each of the adjacent beams may use a different frequency. Thus, a frequency used for a first beam may not be used for a second beam adjacent to the first beam.

Interference occurring between the beams may affect differing systems. For example, a frequency corresponding to a frequency domain of the second beam may be used by a terrestrial communication system. Thus, interference may occur between the terrestrial communication system and the satellite communication system using the frequency.

A common frequency available for the satellite communication system and the terrestrial communication system may exist. Whether such a common frequency is applied may be determined for each country based on a domestic policy.

### SUMMARY

An aspect of the present invention provides a terrestrial communication apparatus and system for operating using an identical frequency to a satellite communication system.

Another aspect of the present invention also provides a terrestrial communication method of using an identical frequency to a satellite communication system.

According to an aspect of the present invention, there is provided a communication method implemented by a terrestrial communication system, the method including detecting a first terminal of a satellite communication system using a first frequency in a first cell, and performing, when the first terminal is not detected in the first cell, a downlink transmission using the first frequency in the first cell.

The communication method may further include setting, when the first terminal is detected in the first cell, the first frequency to be unavailable for the downlink transmission.

The communication method may further include performing the downlink transmission using the second frequency by changing a frequency used for the downlink transmission from the first frequency to a second frequency when the first terminal is detected in the first cell.

The detecting may include receiving location information on the first terminal from the satellite communication system based on a predetermined interval.

The detecting may include updating location data of the first terminal based on the location information.

The detecting may include performing a first monitoring on a random access channel (RACH).

The first terminal included in the first cell may be detected as a result of the first monitoring.

The detecting may further include detecting an identification (ID) of the first terminal when the first terminal is detected in the RACH.

The detecting may further include requesting, when a terminal having the detected ID terminates use of the first frequency, the satellite communication system to provide a notification indicating a termination of use of the first terminal.

The communication method may further include performing a downlink transmission using the second frequency by changing a frequency used for the downlink transmission from the first frequency to a second frequency when the first terminal is detected in the RACH.

When the first terminal is detected in the RACH, the detecting may further include setting the first frequency to be unavailable for the downlink transmission.

The detecting may further include performing a second monitoring on an uplink control channel of the satellite communication system.

The performing of the second monitoring may include resetting a timer for setting the first frequency to be unavailable for the downlink transmission when the first terminal is detected in the first cell through the second monitoring.

The communication method may further include performing a downlink transmission using the second frequency by changing a frequency used for the downlink transmission from the first frequency to the second frequency when the first terminal is detected in the uplink control channel.

When the first terminal is detected in the uplink control channel, the detecting may further include setting the first frequency to be unavailable for the downlink transmission.

The detecting may further include setting the first frequency to be available for the downlink transmission when the first terminal is not detected in the first cell through the second monitoring.

The setting may include setting the first frequency to be available for the downlink transmission based on a result of the first monitoring and whether the timer is expired.

The detecting may include performing a first monitoring on an RACH, and performing a second monitoring on an uplink control channel of the satellite communication system.

The performing may include performing the downlink transmission when the first terminal is not detected in the RACH and the first terminal is not detected in the uplink control channel.

The communication method may further include determining, in a second cell adjacent to the first cell, whether the downlink transmission causes interference in a second terminal using the first frequency of the satellite communication system.

The determining may include detecting the second terminal in the second cell.

The determining may further include calculating a value indicating a degree to which the downlink transmission affects the second terminal when the second terminal is detected.

The determining may include verifying that the downlink transmission does not cause interference in the second terminal when the calculated value is less than a predetermined reference value.

The performing may include performing the downlink transmission when the downlink transmission is verified not to cause interference in the second terminal

According to another aspect of the present invention, there is also provided a terrestrial communication apparatus including a detector to detect a first terminal of a satellite communication system using a first frequency in a first cell, and a downlink unit to perform downlink transmission using the first frequency in the first cell when the first terminal is not detected in the first cell.

When the first terminal is detected in the first cell, the downlink unit may set the first frequency to be unavailable for the downlink transmission.

When the first terminal is detected in the first cell, the downlink unit may perform the downlink transmission using the second frequency by changing a frequency used for the downlink transmission from the first frequency to a second frequency.

The detector may perform a first monitoring on an RACH.

The first terminal included in the first cell may be detected as a result of the first monitoring.

When the first terminal is detected in the RACH, the downlink unit may set the first frequency to be unavailable for the downlink transmission, and perform the downlink transmission by changing a frequency used for the downlink transmission from the first frequency to the second frequency.

The detector may perform a second monitoring on an uplink control channel of the satellite communication system.

When the first terminal is detected in the first cell through the second monitoring, the downlink unit may reset a timer for setting the first frequency to be unavailable for the downlink transmission.

When the first terminal is detected in the uplink control channel, the downlink unit may set the first frequency to be unavailable for the downlink transmission, and perform the downlink transmission using the second frequency by changing a frequency used for the downlink transmission from the first frequency to the second frequency.

According to still another aspect of the present invention, there is also provided a terrestrial communication system including a base station located in a first cell, and a central station to communicate with the base station, wherein the base station may detect a first terminal of a satellite communication system using a first frequency in the first cell, and wherein when the first terminal is not detected in the first cell, the central station may perform downlink transmission using the first frequency in the first cell.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of using a frequency in a terrestrial communication method according to an example embodiment;

FIG. 2 is a diagram illustrating a terrestrial communication system according to an example embodiment;

FIG. 3 is a flowchart illustrating a terrestrial communication method according to an example embodiment;

FIG. 4 is a flowchart illustrating a method of detecting a terminal of a satellite communication system according to an example embodiment;

FIG. 5 is a flowchart illustrating a method for performing a monitoring on a random access channel (RACH) according to an example embodiment;

FIG. 6 is a flowchart illustrating a method of performing a monitoring on an uplink control channel according to an example embodiment;

FIG. 7 is a flowchart illustrating a method of determining whether downlink transmission causes interference in a terminal of an adjacent cell according to an example embodiment;

FIG. 8 is a block diagram illustrating escape frequency blocks according to an example embodiment; and

FIG. 9 is a block diagram illustrating a configuration of a terrestrial communication apparatus according to an example embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The exemplary embodiments may, however, be embodied in many different forms and should not be construed as limited to the embodiments set forth herein. Rather, these embodiments are provided so that this disclosure will be thorough and complete, and all technical spirits falling within the equivalent scope thereof should be interpreted as being included in the scope of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Hereinafter, embodiments of the present invention will be described in detail with reference to the accompanying drawings. When it is determined detailed description related to a known function or configuration they may render the purpose of the present invention unnecessarily ambiguous in describing the present invention, the detailed description will be omitted here.

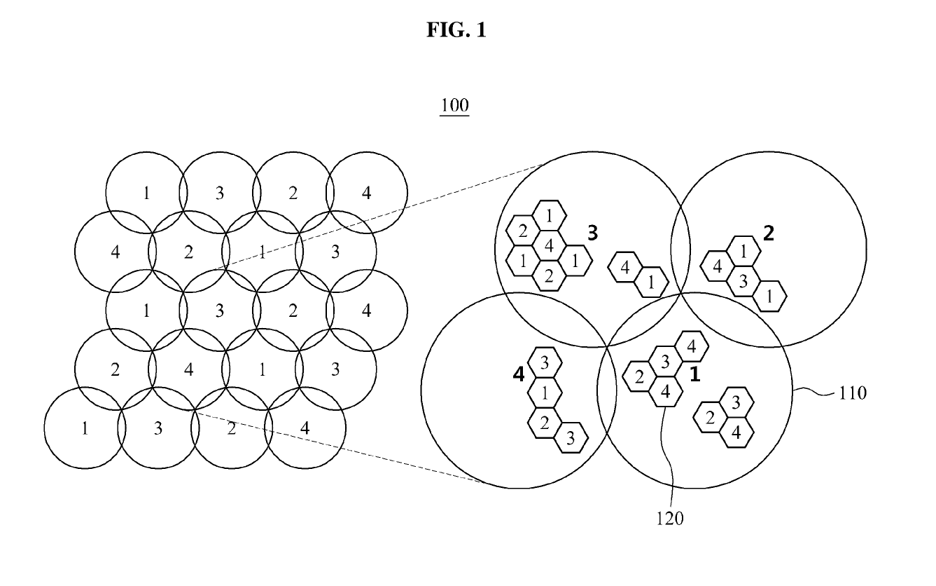

FIG. 1 is a diagram illustrating an example of using a frequency in a terrestrial communication method according to an example embodiment.

Referring to FIG. 1, each number positioned at a center of an area indicated by a circle may indicate a frequency used in the area. The number may indicate a frequency used by a beam of a satellite communication system. Each number included in an area indicated by a hexagon may indicate a frequency used by a terrestrial communication system.

In each area indicated by the circle and each area indicated by the hexagon, an identical number may indicate an identical frequency. For example, “1” of the area indicated by the circle and “1” of the area indicated by the hexagon may indicate identical frequencies.

In an example embodiment, the satellite communication system and the terrestrial communication system may communicate using a first frequency through a fourth frequency. One of the first frequency through the fourth frequency may be used in each of the areas indicated by the circle and the areas indicated by the hexagon with reference to FIG. 1.

A first beam of the satellite communication system may cover a first area 110. A terminal communicating with a satellite in the first area 110 may use the first frequency of the first beam.

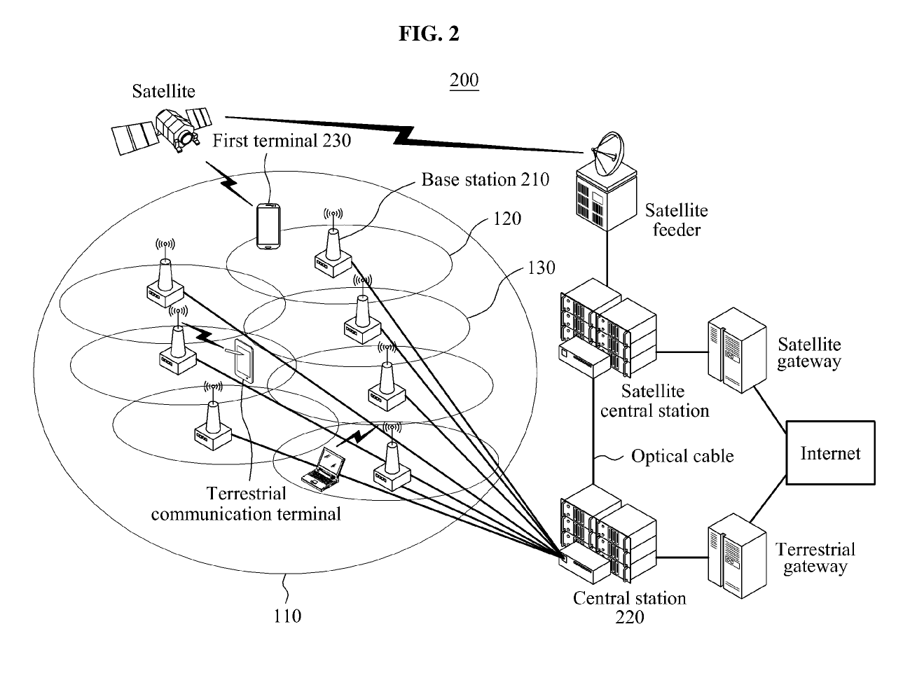

For example, in FIG. 2, the terrestrial communication system may communicate using the fourth frequency in a first cell of the first area 110 in order to prevent interference with the satellite communication system.

In general, to prevent interference between heterogeneous communications, the first frequency may not be used as a frequency of a terrestrial communication in the first area 110. However, when the terrestrial communication does not cause interference in a satellite communication, the terrestrial communication system may use the first frequency in the first area 110.

When the terrestrial communication system uses the first frequency in the first area 110, a frequency availability of the terrestrial communication may be improved.

Hereinafter, descriptions about a method of allowing the terrestrial communication system to use the first frequency when the first beam of the satellite communication system uses the first frequency and the terrestrial communication system is provided in the first cell 120 included in the first area 110 of the first beam will be provided with reference to FIGS. 2 through 9.

FIG. 2 is a diagram illustrating a terrestrial communication system 200 according to an example embodiment.

The terrestrial communication system 200 may be a system including at least one device.

In an example, the terrestrial communication system 100 may include a base station 210 and a central station 220.

The base station 210 may be included in the first cell 120.

The central station 220 may communicate with the base station 210. The communicating may be based on a wired communication or a wireless communication.

In an example, the terrestrial communication system 100 may be connected to a satellite communication system as shown in FIG. 2.

To improve performance of the terrestrial communication system 200, a method of reducing interference occurring due to a frequency shared between the satellite communication system and the terrestrial communication system 200, and a method of allowing the terrestrial communication system 200 to use, in the first cell 120 of the first area 110, a first frequency used by a first beam may be employed.

When a first terminal 230 of the satellite communication system is included in the first cell 120, the terrestrial communication system 200 may not use an uplink frequency of the satellite communication system and a downlink frequency of the satellite communication system in the first cell 120.

However, when the first terminal 230 is not included in the first cell 120, the terrestrial communication system 200 may use the downlink frequency of the satellite communication system in the first cell 120.

To allow the terrestrial communication system 200 to use the downlink frequency in the first cell 120, the terrestrial communication system 100 and the satellite communication system may exchange information to each other.

The first terminal 230 of the satellite communication system may communicate with a satellite using the first frequency. The satellite may transmit, to a satellite feeder, information on a communication with the first terminal 230. The satellite feeder may transmit the received information to a satellite central station. The satellite central station may be connected to the central station 220 of the terrestrial communication system 200. Thus, the satellite central station may transmit the information to the central station 220 of the terrestrial communication system 200.

Hereinafter, descriptions about a method of allowing the terrestrial communication system 200 to use the downlink frequency of the satellite communication system in the first cell 120 will be provided.

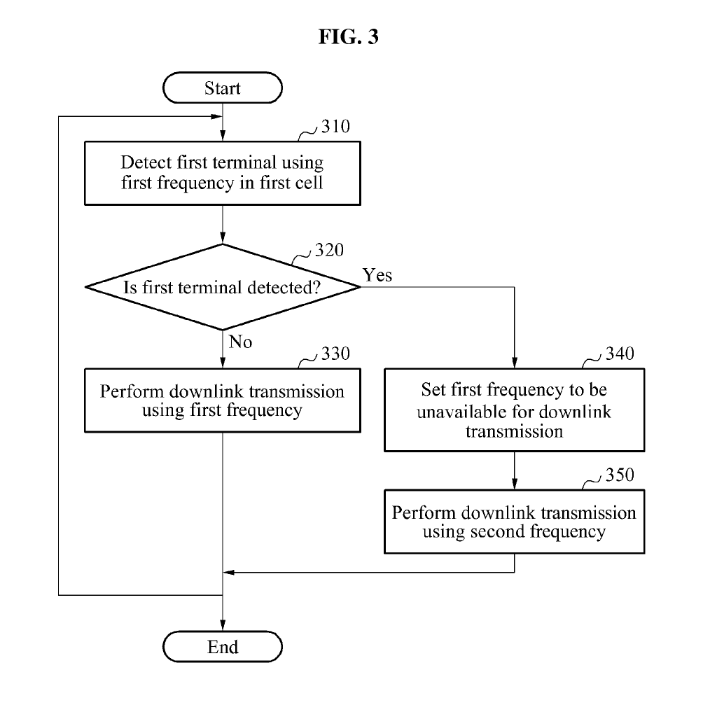

FIG. 3 is a flowchart illustrating a terrestrial communication method according to an example embodiment.

In operation 310, the base station 210 may detect the first terminal 230 of a satellite communication system using a first frequency in the first cell 120.

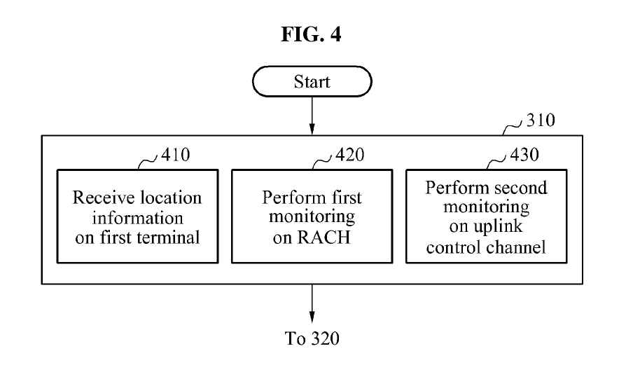

Descriptions about operation 310 will be provided with reference to FIGS. 4 through 6.

In operation 320, the central station 220 may determine whether the first terminal 230 is detected.

When the first terminal 230 is detected, operation 340 may be performed.

When the first terminal 230 is not detected, operation 330 may be performed.

In operation 330, when the first terminal 230 is not detected in the first cell 120, the central station 220 may perform a downlink transmission using the first frequency in the first cell 120.

The downlink transmission may be performed between the base station 210 and a terminal of the terrestrial communication system 200 in the first cell 120.

In operation 340, when the first terminal 230 is detected in the first cell 120, the central station 220 may set the first frequency to be unavailable for the downlink transmission.

In operation 350, the central station 220 may perform the downlink transmission by changing a frequency used for the downlink transmission from the first frequency to a second frequency.

When operation 330 or operation 350 is performed, operation 310 may be performed again.

FIG. 4 is a flowchart illustrating a method of detecting a terminal of a satellite communication system according to an example embodiment.

Operation 310 of FIG. 3 may include operations 410 through 430 described below.

In operation 410, the central station 220 may receive location information on the first terminal 230 from a satellite communication system. The location information may be received based on a predetermined interval.

The central station 220 may update location data on the first terminal based on the location information.

For example, the location information may be unique location information acquired by a global positioning system (GPS).

The central station 220 may receive the location information on the first terminal 230, and verify a cell including the first terminal 230 based on the received location information.

The central station 220 may perform a downlink transmission using a first frequency in a cell, aside from the cell including the first terminal 130 and a cell corresponding to a value indicating whether a degree to which the downlink transmission is affected is greater than or equal to a predetermined value.

In operation 420, the base station 210 may perform a first monitoring on a random access channel (RACH).

A terminal initiating a satellite communication in the first cell 120 may use the RACH when the satellite communication is initiated. Thus, the first terminal 230 initiating the satellite communication may be detected through a monitoring performed on the RACH. For example, the first terminal 230 of the first cell 120 may be detected as a result of the first monitoring.

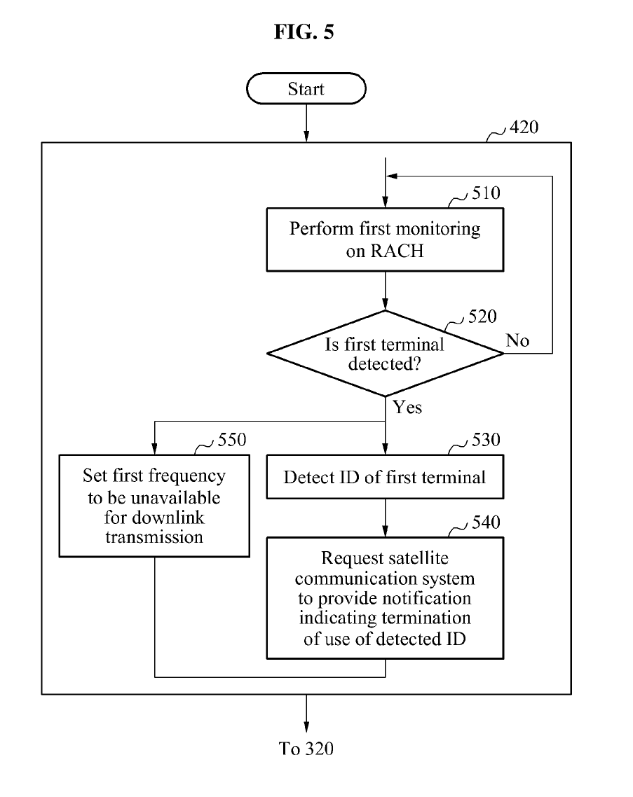

Descriptions about operation 420 will be provided with reference to FIG. 5.

In operation 430, the base station 210 may perform a second monitoring on an uplink control channel of the satellite communication system.

When compared to a voice communication, a data communication may be asymmetric in terms of uplink data transmission and downlink data transmission. Thus, monitoring of a control channel periodically communicating with a satellite may be more efficient than monitoring of a data channel.

When the first terminal 230 initiating the satellite communication at an external area of the first cell 120 is relocated into the first cell 120, the first terminal 230 may be detected through a monitoring performed on the uplink control channel. For example, the first terminal 230 of the first cell 120 may be detected as a result of the second monitoring.

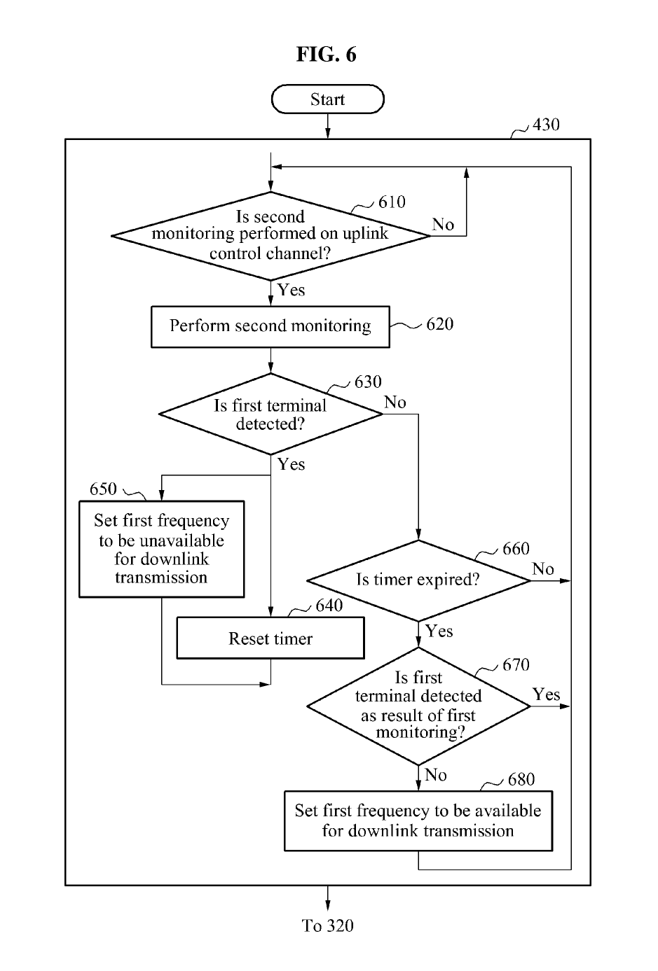

Descriptions about operation 430 will be provided with reference to FIG. 6.

Each of operations 410 through 430 may be performed independently. For example, operation 410 may be performed while operations 420 and 430 are not performed. Also, operations 420 and 430 may be performed while operation 410 is not performed.

FIG. 5 is a flowchart illustrating a method for performing a monitoring on an RACH according to an example embodiment.

Operation 420 of FIG. 4 may include operations 510 through 550 described below.

In operation 510, the base station 210 may perform a first monitoring on the RACH.

In operation 520, the central station 220 may detect the first terminal 230 as a result of the first monitoring.

When the first terminal 230 is detected in the RACH, operations 530 and 540 may be performed.

When the first terminal 230 is not detected in the RACH, operation 510 may be performed again. Also, when the first terminal 230 is not detected in the RACH, operation 320 may be performed.

In operation 530, the central station 220 may detect an identification (ID) of the first terminal 230.

In operation 540, when a terminal having the detected ID terminates a use of the first frequency, the central station 220 may request a satellite communication system to provide a notification indicating a termination of the use of the first frequency. For example, to be informed of a point in time at which the first terminal 230 terminates the use of the first frequency, the central station 220 may request the satellite communication system to provide a notification indicating that the first terminal 230 terminates the use of the first frequency.

When the satellite communication system provides the notification, the central station 220 may set the first frequency to be available for downlink transmission.

When the first terminal 230 of the satellite communication system using the first frequency in the first cell 120 is provided in plural, the central station 220 may set the first frequency to be available for the downlink transmission at a point in time at which all of a plurality of first terminals terminates the use of the first frequency.

In operation 550, the central station 220 may set the first frequency to be unavailable for the downlink transmission.

Operations 530 and 550 may be performed in parallel. For example, when operation 530 is performed, operation 550 may be performed. As another example, operation 530 may not be performed.

When operation 540 or operation 550 is performed, operation 320 may be performed.

FIG. 6 is a flowchart illustrating a method of performing a monitoring on an uplink control channel according to an example embodiment.

Operation 430 of FIG. 4 may include operations 610 through 680 described below.

In operation 610, the base station 210 may determine whether a second monitoring is performed on an uplink control channel of a satellite communication system.

Whether the second monitoring is performed may be received from an operator of the terrestrial communication system 200.

When the second monitoring is performed, operation 620 may be performed.

In operation 620, the base station 210 may perform the second monitoring on the uplink control channel of the satellite communication system.

The base station 210 may perform the second monitoring on the uplink control channel during a predetermined period of time.

In operation 630, the central station 220 may detect the first terminal 230 as a result of the second monitoring.

When the first terminal 230 is detected in the first cell 120 through the second monitoring, operations 640 and 650 may be performed.

When the first terminal 230 is not detected in the first cell 120 through the second monitoring, operation 660 may be performed.

In operation 640, the central station 220 may reset a timer for setting the first frequency to be unavailable for the downlink transmission.

The central station 220 may operate the timer when the timer is not in operation.

The central station 220 may set the timer based on an initial value when the timer is in operation.

In operation 650, the central station 220 may set the first frequency to be unavailable for the downlink transmission.

When operation 640 or operation 650 is performed, operation 320 may be performed.

In operation 660, when the first terminal 230 is not detected in the first cell 120 through the second monitoring, the central station 220 may determine whether the timer is expired.

In operation 670, the central station 220 may determine whether the first terminal 230 is detected as a result of a first monitoring.

In operation 680, when the first terminal 230 is not detected in the first cell 120 through the second monitoring, the central station 220 may set the first frequency to be available for the downlink transmission.

The central station 220 may set the first frequency to be available for the downlink transmission based on the result of the first monitoring and whether the timer is expired.

For example, when the timer is expired and the first terminal 230 is not detected as the result of the first monitoring, the central station 220 may set the first frequency to be available for the downlink transmission.

When operation 680 is performed, operation 610 may be performed again. Also, when operation 680 is performed, operation 320 may be performed.

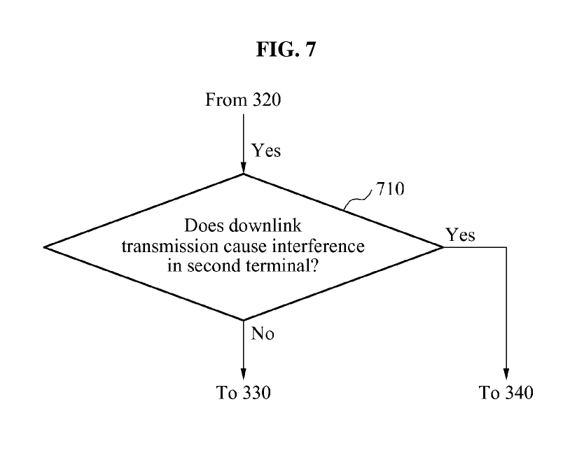

FIG. 7 is a flowchart illustrating a method of determining whether downlink transmission causes interference in a terminal of an adjacent cell according to an example embodiment.

Operation 710 may be performed after operation 320 is performed.

In operation 710, the central station 220 may determine whether the downlink transmission causes interference in a second terminal using a first frequency of a satellite communication system in the second cell 130 adjacent to the first cell 120.

The central station 220 may detect the second terminal in the second cell 130 using a base station included in the second cell 130.

When the second terminal is detected, the central station 220 may calculate a value indicating a degree to which the downlink transmission affects the second terminal.

When the calculated value is less than a predetermined reference value, the central station 220 may verify that the downlink transmission does not cause interference in the second terminal.

When the downlink transmission is verified not to cause interference in the second terminal, operation 330 may be performed.

When the downlink transmission is verified to cause interference in the second terminal, operation 340 may be performed.

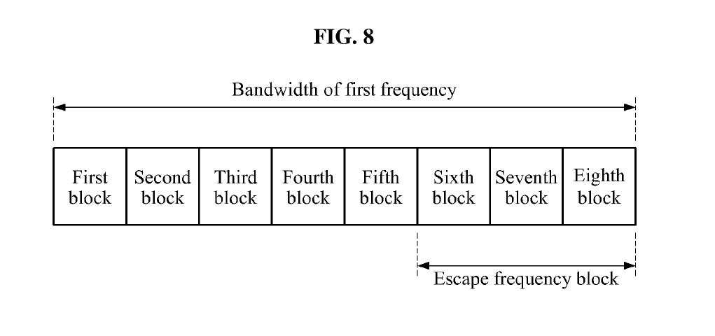

FIG. 8 is a block diagram illustrating escape frequency blocks according to an example embodiment.

When the first terminal 230 is detected during a downlink transmission using a first frequency, suspension of the downlink transmission using the first frequency may be necessary. Despite a need for suspension, the downlink transmission using a second frequency may not be performed. When the downlink transmission using the second frequency is not performed, the downlink transmission using the first frequency may be temporarily continued.

When the downlink transmission using the first frequency is continued, the central station 220 may set an escape frequency block among a plurality of blocks of the first frequency, in order to reduce interference with a satellite communication system.

In operation 350, when the downlink transmission using the first frequency is temporarily continued because the downlink transmission using the second frequency is not performed, the central station 220 may perform downlink transmission using an escape frequency block of the first frequency.

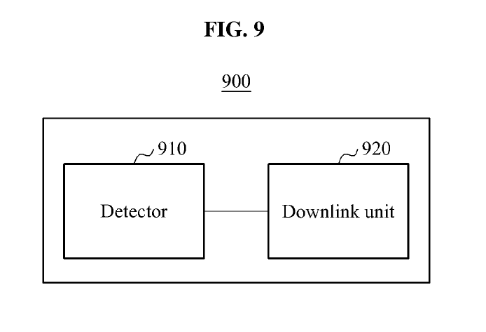

FIG. 9 is a block diagram illustrating a configuration of a terrestrial communication apparatus 900 according to an example embodiment.

The aforementioned terrestrial communication system 200 may be implemented in the terrestrial communication apparatus 900.

The terrestrial communication apparatus 900 may include a detector 910 and a downlink unit 920.

The terrestrial communication apparatus 900 may correspond to the terrestrial communication system 200. The detector 910 may correspond to the base station 210. The downlink unit 920 may correspond to the central station 220.

Thus, in the foregoing embodiments, the terrestrial communication system 200 may be substituted to the terrestrial communication apparatus 900. Also, the base station 210 may be substituted to the detector 910, and the central station 220 may be substituted to the downlink unit 920. Communication between the base station 210 and the central station 220 may be substituted to communication between the detector 910 and the downlink unit 920. For example, descriptions about functions, operations, and configurations related to the terrestrial communication system 200, the base station 210, and the central station 220 may be applied to the terrestrial communication apparatus 900, the detector 910, and the downlink unit 920.

For example, in the terrestrial communication apparatus 900, the detector 910 may detect the first terminal 230 of a satellite communication system using a first frequency in the first cell 120. When the first terminal 230 is not detected in the first cell 120, the downlink unit 920 may perform downlink transmission using the first frequency in the first cell 120.

Descriptions provided with reference to FIGS. 2 through 8 may be identically applied and thus, repeated descriptions will be omitted for increased clarity and conciseness.

According to an aspect of the present invention, it is possible to provide a terrestrial communication method, an apparatus, and a system.

According to another aspect of the present invention, it is possible to provide a terrestrial communication method, an apparatus, and a system for using an identical frequency to a satellite communication system.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical disks; and hardware devices that are specially configured to store and perform program instructions, such as read-only memory (ROM), random access memory (RAM), flash memory, and the like. Examples of program to instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A communication method implemented by a terrestrial communication system, the method comprising:
detecting a first terminal of a satellite communication system using a first frequency in a first cell; and
performing, when the first terminal is not detected in the first cell, a downlink transmission using the first frequency in the first cell.

2. The method of claim 1, further comprising:
setting, when the first terminal is detected in the first cell, the first frequency to be unavailable for the downlink transmission.

3. The method of claim 2, further comprising:
performing the downlink transmission using the second frequency by changing a frequency used for the downlink transmission from the first frequency to a second frequency when the first terminal is detected in the first cell.

4. The method of claim 1, wherein the detecting comprises receiving location information on the first terminal from the satellite communication system based on a predetermined interval, and updating location data of the first terminal based on the location information.

5. The method of claim 1, wherein the detecting comprises performing a first monitoring on a random access channel (RACH), and the first terminal included in the first cell is detected as a result of the first monitoring.

6. The method of claim 5, wherein the detecting further comprises detecting an identification (ID) of the first terminal when the first terminal is detected in the RACH and requesting, when a terminal having the detected ID terminates use of the first frequency, the satellite communication system to provide a notification indicating a termination of use of the first terminal.

7. The method of claim 5, further comprising:
performing a downlink transmission using the second frequency by changing a frequency used for the downlink transmission from the first frequency to a second frequency when the first terminal is detected in the RACH,
wherein when the first terminal is detected in the RACH, the detecting further comprises setting the first frequency to be unavailable for the downlink transmission.

8. The method of claim 5, wherein the detecting further comprises performing a second monitoring on an uplink control channel of the satellite communication system, and the performing of the second monitoring comprises resetting a timer for setting the first frequency to be unavailable for the downlink transmission when the first terminal is detected in the first cell through the second monitoring.

9. The method of claim 8, further comprising:
performing a downlink transmission using the second frequency by changing a frequency used for the downlink transmission from the first frequency to the second frequency when the first terminal is detected in the uplink control channel,
wherein when the first terminal is detected in the uplink control channel, the detecting further comprises setting the first frequency to be unavailable for the downlink transmission.

10. The method of claim 8, wherein the detecting further comprises setting the first frequency to be available for the downlink transmission when the first terminal is not detected in the first cell through the second monitoring, and the setting comprises setting the first frequency to be available for the downlink transmission based on a result of the first monitoring and whether the timer is expired.

11. The method of claim 1, wherein the detecting comprises performing a first monitoring on an RACH, and performing a second monitoring on an uplink control channel of the satellite communication system, and
wherein the performing comprises performing the downlink transmission when the first terminal is not detected in the RACH and the first terminal is not detected in the uplink control channel.

12. The method of claim 11, further comprising:
determining, in a second cell adjacent to the first cell, whether the downlink transmission causes interference in a second terminal using the first frequency of the satellite communication system,
wherein the determining comprises detecting the second terminal in the second cell, and calculating a value indicating a degree to which the downlink transmission affects the second terminal,
wherein the determining comprises verifying that the downlink transmission does not cause interference in the second terminal when the calculated value is less than a predetermined reference value, and
wherein the performing comprises performing the downlink transmission when the downlink transmission is verified not to cause interference in the second terminal.

13. A terrestrial communication apparatus comprising:
a detector to detect a first terminal of a satellite communication system using a first frequency in a first cell; and
a downlink unit to perform a downlink transmission using the first frequency in the first cell when the first terminal is not detected in the first cell.

14. The apparatus of claim 13, wherein when the first terminal is detected in the first cell, the downlink unit sets the first frequency to be unavailable for the downlink transmission.

15. The apparatus of claim 14, wherein when the first terminal is detected in the first cell, the downlink unit performs the downlink transmission using the second frequency by changing a frequency used for the downlink transmission from the first frequency to a second frequency.

16. The apparatus of claim 13, wherein the detector performs a first monitoring on a random access channel (RACH), and the first terminal included in the first cell is detected as a result of the first monitoring.

17. The apparatus of claim 16, wherein when the first terminal is detected in the RACH, the downlink unit sets the first frequency to be unavailable for the downlink transmission, and performs the downlink transmission by changing a frequency used for the downlink transmission from the first frequency to the second frequency.

18. The apparatus of claim 16, wherein the detector performs a second monitoring on an uplink control channel of the satellite communication system, and
wherein when the first terminal is detected in the first cell through the second monitoring, the downlink unit resets a timer for setting the first frequency to be unavailable for the downlink transmission.

19. The apparatus of claim 18, wherein when the first terminal is detected in the uplink control channel, the downlink unit sets the first frequency to be unavailable for the downlink transmission, and performs the downlink transmission using the second frequency by changing a frequency used for the downlink transmission from the first frequency to the second frequency.

20. A terrestrial communication system comprising:
a base station located in a first cell; and
a central station to communicate with the base station,
wherein the base station detects a first terminal of a satellite communication system using a first frequency in the first cell, and
wherein when the first terminal is not detected in the first cell, the central station performs downlink transmission using the first frequency in the first cell.
